(19) United States
(12) Patent Application Publication
(10) Pub. No.: US 2017/0270790 A1
(43) Pub. Date: Sep. 21, 2017

(54) Vehicle Prediction Module

(71) Applicant: New York City Transit Authority, New York, NY (US)

(72) Inventors: Bruce D. Neiger, Merrick, NY (US); Philip Jon Matuskiewicz, Great Valley, NY (US); David A. Laidig, Ridgewood, NY (US); Michael S. Frumin, Brooklyn, NY (US)

(73) Assignee: New York City Transit Authority, New York, NY (US)

(21) Appl. No.: 15/154,675

(22) Filed: May 13, 2016

Related U.S. Application Data
(60) Provisional application No. 62/162,563, filed on May 15, 2015.

(51) Int. Cl. G08G 1/123

(52) U.S. Cl. CPC G08G 1/123

(57) ABSTRACT

The present invention improves the way how a vehicle's arrival time at a stop may be determined. When a system receives at least one vehicle location record, it may extract trip data from such report. While previous trip data comprising scheduled travel time, historical travel times, and recent travel times with respect to the same vehicle's trip along a route may be extracted from a database, trip data from recent vehicle location records may be uploaded into the database as updates. The most recent stop and at least one future stop may be identified. Using both extracted and updated data, the present invention may establish links between stops, determine a travel distance for each link, and estimate a link travel time for each travel distance based upon a weighted composite. Link travel times may be aggregated to determine estimated times of arrival, which can be uploaded for user retrieval.

### CROSS REFERENCE TO RELATED APPLICATIONS

This application claims the benefit of U.S. Provisional Application No. 62/162,563, to Neiger et al., filed May 15, 2015, and entitled “Vehicle Prediction Module”, the entire contents of which are incorporated herein by reference.

### BACKGROUND OF THE INVENTION

Demand for more accurate arrival time predictions of transit vehicles has dramatically increased over the years as more travelers choose to take public and commercial transportation. Current estimation systems for regularly scheduled, recurrent service vehicles on publicly managed roadway networks rely on only one or two layers of dependent factors.

The most basic layer involves a vehicle's current schedule. A common denominator for this basic layer is the assumption that travel time is unaffected by external conditions. The only deviation from the schedule that these systems consider is the vehicle's current deviation from that very schedule. For example, if a transit bus is scheduled to take 30 minutes to arrive at a stop of interest from a particular location, the current system will always predict that same scheduled 30 minutes as the estimated amount of time for the transit bus to arrive. If the transit bus is currently on-time, the current system will predict the transit bus to arrive on-time. If the transit bus is running eight minutes late, the current system will estimate that the transit bus will arrive eight minutes late. While systems that rely only on this layer are useful to a certain degree, they are not robust. Additionally, these systems fail to account for frequent errors caused by scheduled traffic-affecting events, such as construction, or other unexpected adverse conditions, such as high traffic volume, congestion, accidents, construction, events, etc.

Another layer is historical travel times of the transit vehicle for a given trip. Current estimation systems that implement this layer modify a vehicle's estimated travel time to a stop of interest based on travel times for previous trips. While this approach may capture better results in estimating arrival times for transit vehicles, this layer has its problems too. These include not being robust and being prone to errors, especially those caused by emergent conditions on the day of travel.

Both these prediction layers are often implemented in travel agencies' communications to stakeholders, based on a system, such as an Automatic Vehicle Location (AVL) system, that locates their vehicles in real time. The predictions tend to be reasonably accurate on travel days that conform to general expectations or to those experienced on the network over a historical period. However, they also tend to produce unacceptable errors on days with emergent travel conditions, or in the early portions of a network change or upgrade. For instance, such a system's historical travel time layer may take several days to recognize that there is a long-term construction project in the vehicle's path, and to consider or realize the effects of such project before making any adjustment to the vehicle's estimated arrival time.

Because of these problems, what is needed is an improved system that can more robustly provide real-time, accurate estimated arrival times for a transit vehicle. The system should be able to recognize and readily adjust its estimations when considering extrinsic and/or adverse conditions, such as weather conditions, accidents, road construction, special events, expected or unexpected high traffic volume and congestion, etc.

### BRIEF SUMMARY OF THE INVENTION

The present invention takes and converts data from vehicle location records, scheduled travel times for each stop along a trip, historical travel times, and recent travel times into an estimated time of arrival (ETA) for each stop of a vehicle on a particular trip.

### BRIEF DESCRIPTION OF THE SEVERAL VIEWS OF THE DRAWINGS

The accompanying drawings, which are incorporated in and form a part of the specification, illustrate an embodiment of the present invention and, together with the description, serve to explain the principles of the invention.

FIG. 1 shows an illustrative flow diagram for determining the estimated time of arrival of a vehicle at a stop as per an aspect of an embodiment of the present invention.

FIG. 2 shows another illustrative flow diagram for determining the estimated time of arrival of a vehicle at a stop as per an aspect of an embodiment of the present invention.

FIG. 3 shows a schematic block diagram of a processor on a computing device configured for determining a vehicle's estimated time of arrival as per an aspect of an embodiment of the present invention.

FIG. 4 shows another schematic block diagram of a processor on a computing device configured for determining a vehicle's estimated time of arrival as per an aspect of an embodiment of the present invention.

FIG. 5 shows a schematic block diagram of a non-transitory, tangible computer readable medium with instructions for determining the estimated time of arrival of a vehicle for a stop as per an aspect of an embodiment of the present invention.

FIG. 6A shows an example of a case scenario of a vehicle location record that is considered at the stop for a single stop as per an aspect of an embodiment of the present invention.

FIG. 6B shows another example of a case scenario of a vehicle location record that is considered at the stop for a single stop as per an aspect of an embodiment of the present invention.

FIG. 6C shows an example of a case scenario of no vehicle location record that is considered at the stop for a single stop, but with one or more vehicle location records before and after the stop, as per an aspect of an embodiment of the present invention.

FIG. 6D shows an example of a case scenario of at least two vehicle location records that are considered at the stop for a single stop as per an aspect of an embodiment of the present invention.

FIG. 6E shows an example of a case scenario of at least two vehicle location records that are considered at the stop for a single stop as per an aspect of an embodiment of the present invention.

FIG. 6F shows another example of a case scenario of at least two vehicle location records that are considered at the stop for a single stop as per an aspect of an embodiment of the present invention.

FIG. 7A shows an example of an exception case scenario of the delta and sigma overlap at a non-terminal stop as per an aspect of an embodiment of the present invention.

FIG. 7B shows another example of an exception case scenario of the delta and sigma overlap at a non-terminal stop as per an aspect of an embodiment of the present invention.

FIG. 8A shows an example of all upstream stops having been assigned departure times as per an aspect of an embodiment of the present invention.

FIG. 8B shows an example of one non-terminal stop without a completed departure time, and the current vehicle location record is received at the terminal, as per an aspect of an embodiment of the present invention.

FIG. 8C shows an example of an exception case where one or more regular stops are within the terminal stop as per an aspect of an embodiment of the present invention.

FIG. 8D shows another example of an exception case where one or more regular stops are within the terminal stop as per an aspect of an embodiment of the present invention.

FIG. 8E shows example of how FIG. 8D is corrected as an aspect of an embodiment of the present invention.

FIG. 9A shows an example of a standard case for departure time calculation of the origin stop (T) as per an aspect of an embodiment of the present invention.

FIG. 9B shows an example of an exception case for departure time calculation of the origin stop (T) as per an aspect of an embodiment of the present invention.

FIG. 9C shows an example of how FIG. 9B is corrected as an aspect of an embodiment of the present invention.

FIG. 10 shows an illustrative data flow diagram of an arrival and departure calculator workflow as per an aspect of an embodiment of the present invention.

FIG. 11 shows a schematic block diagram of an overview of a system as per an aspect of an embodiment of the present invention.

FIG. 12 shows an illustration of the system in use as per an aspect of an embodiment of the present invention.

FIG. 13 shows results from test runs on Metropolitan Transportation Authority (MTA) New York City Transit (NYCT) Bus X1 as per an aspect of an embodiment of the present invention.

FIG. 14 shows results from test runs on MTA NYCT Bus M15-Select Bus Service (SBS) as per an aspect of an embodiment of the present invention.

FIG. 15 shows results from test runs on MTA NYCT Bus M34A-SBS as per an aspect of an embodiment of the present invention.

FIG. 16 shows results from test runs on MTA NYCT Bus B63 as per an aspect of an embodiment of the present invention.

FIG. 17 shows results from test runs on MTA NYCT Bus S40 as per an aspect of an embodiment of the present invention.

FIG. 18 shows results from test runs on MTA NYCT Bus S79-SBS as per an aspect of an embodiment of the present invention.

### DETAILED DESCRIPTION OF THE INVENTION

The present invention permits a user to obtain improved, real-time estimated times of arrival (ETA) of a vehicle for a particular stop, stop of interest, or destination along a vehicle's trip or route. Types of vehicles are those involved in land, sea, and/or air transportation that make regularly scheduled recurrent trips. As per an aspect of the present invention, one such vehicle is a bus, such as a New York City Transit bus. Other examples of vehicles include, but are not limited to, trucks, shuttles, vans, cars, taxis, motorcycles, mopeds, trains, light rail, subways, aircraft, helicopters, drones, boats, ferries, ships, etc.

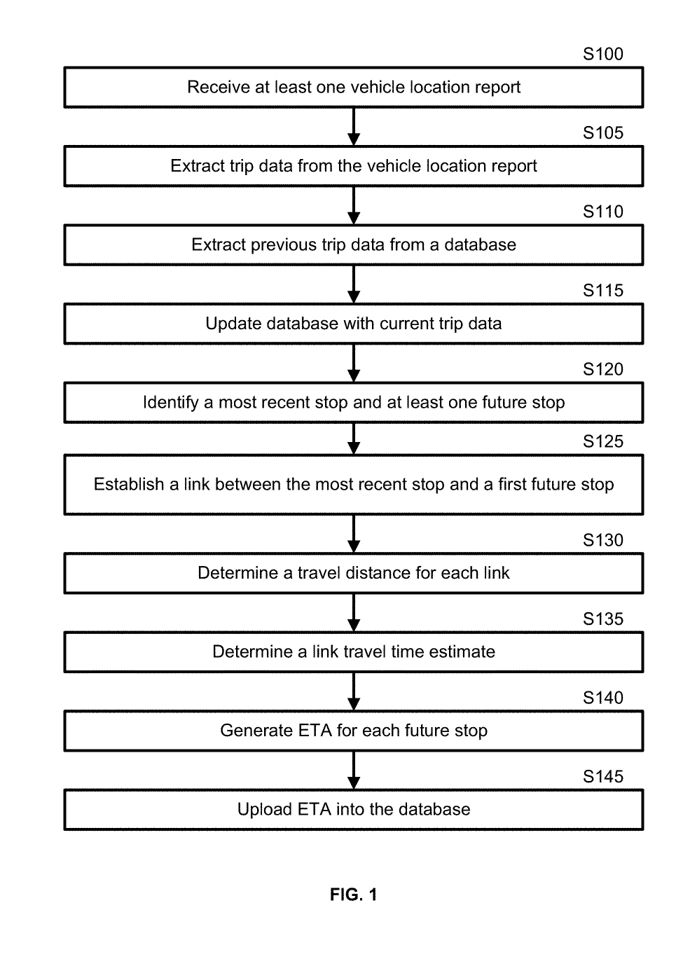

Referring to FIG. 1, the present invention describes a method for determining a vehicle's ETA at a stop. Generally, this method comprises a multitude of processes that may begin to operate upon a processor's initial receipt of the vehicle's vehicle location record after the vehicle's departure from its origin. These processes may continue to iteratively operate until the vehicle arrives at its final destination. To perform each of these processes, a processor on a computing device may be used. Non-limiting examples of a computing device include a computer; a computing machine having a central processing unit and a memory; a server; mobile device (e.g., laptop, tablet, smartphone, smartwatch, personal digital assistant, etc.); etc.

First, at least one vehicle location record need to be received, in real time in intervals, from the vehicle traveling on a trip or along a route S100. The vehicle location record is a compilation of trip data that includes static data and dynamic data with respect to the vehicle and its trip or route. As one embodiment, the present invention may be configured to mandate that a certain minimum number (e.g., three) of vehicle location records must be received. Without receiving updated data in real time, existing data may be treated as old or be discarded.

Static data means data that remains constant or infrequently changes. Static data may include vehicle identification (e.g., make, model, vehicle identification (such as bus number, aircraft number, ship number, etc.), line of service, seating capacity, etc.); a route or trip indicator such as a destination sign indicating final destination; operator login (e.g., vehicle operator's information and/or credentials); route or path taken; stops (e.g., bus stops, train stops, weigh stations, gates, landing pads, docks, ports, etc.); intersections; buoys; etc. A stop may also refer to any place, destination, or location of interest along a travel plan, trip, or route, prior to and including the end point.

Dynamic data means data that frequently changes, experiences updates, or is otherwise not constant. Such data may include timestamp; location or position; vehicle speed; weather conditions; road conditions; direction or heading; etc. Communicating location, direction, and heading data may be achieved by following the National Marine Electronics Association (NMEA) 0183 standard or an equivalent format.

Route means one or more stopping patterns that are scheduled to have at least one vehicle perform as a trip. Stopping pattern means a sequence of one or more stops (i.e., a location where a vehicle may pull over to receive and/or discharge passengers). Trip means one implementation of one stopping pattern. The trip may also dictate the specific path that a vehicle takes to follow a given stopping pattern. A trip may be scheduled or unscheduled. A scheduled trip means the trip comprises a known stopping pattern, travel path, and expected time of departure and/or arrival for each stop under generally expected conditions. An unscheduled trip means a trip has not been scheduled or is unauthorized.

As the vehicle travels along its path, a global positioning system (GPS) transponder onboard the vehicle may generate vehicle location records and transmit them in timed intervals to a processor. Temporal, interval distribution helps maintain real-time statuses on vehicular arrival times. As a preferred embodiment, a timed interval constitutes every 30 seconds. However, alternate timed intervals (such as 10-second intervals, 15-second intervals, 45-second intervals, 1-minute intervals, 2-minute intervals, etc.) may also be set based on user preference.

While not necessarily perfect, each vehicle location record should have a high degree of reliability and accuracy. For instance, the vehicle location record should identify, in real time, the route and trip being operated, vehicle identifier, speed, etc.

However, real world data often includes real world imperfections. For example, where there are device failures, communication failures, signal refraction, noise, or other signal interference, the exact location of the vehicle may not be able to be reported or accurately identified. In such case, a server may be down or the GPS transponder may have a tendency to report the vehicle at a previous location after having been reported that it already went past such location. These failures may provide the illusion that the vehicle is either traveling backwards or in a reverse direction. As another example, there may be sporadic communication, or the vehicle enters a cellular dead zone. As a result, potential break(s) in status updates means that less data are available, which would likely cause inferences and prediction to become less reliable and/or less accurate. As yet another example, there may be situations where vehicle stops may be mapped too close to each other so that they cannot always be reliably distinguished by GPS. Other examples include failure to receive any vehicle location record; GPS inaccuracies (also known as GPS jitter); etc. Thus, to account for these potential, exemplified real world situations, the processor is configured to account for real world imperfections, network topography, transmission reliability, and GPS inaccuracies by discarding certain data (i.e., false, impossible, old, bad, etc.) and by incorporating multiple data sources as described herein (such as scheduled travel times; historical travel times; and recent travel times).

Second, trip data from at least one of the vehicle location records may be extracted S105.

Third, from at least one database, previous trip data comprising a scheduled travel time for each stop of the trip, historical travel times, and recent travel times may be extracted S110.

Scheduled travel time refers to the time when a vehicle is expected to depart from a particular stop. This time may be set by an agency or organization and can be found, for example, on a time table.

Historical travel times refer to the times when a vehicle departed from a particular stop at a similar time of day over a span of time (e.g., days, weeks, etc.) in the past. In general, historical travel times provide a statistically reasonable sample of departure times based on an average typical trip for vehicles per route with the same stopping pattern under similar expected traffic conditions. As a preferred embodiment, the system may extract about 300 trips occurring during the same hour for about 30 days prior to a user's request for a vehicle's current trip.

For a vehicle to have the same stopping pattern as another, all the vehicles must be scheduled to stop at the same stop along a route. Any deviation will constitute a different stopping pattern. For instance, a local M4 Metropolitan Transportation Authority (MTA) New York City Transit (NYCT) Bus will not have the same stopping pattern as the M4 Limited Service MTA NYCT Bus. Even though both run the same path along the route, the M4 Limited Service has fewer stops than the local M4. As another example, an MTA NYCT “3” train running part-time will not stop at all the stops that an MTA NYCT “3” train running full-time despite both running on the same rail.

Recent travel times refer to the times when a vehicle has departed from a particular stop over a certain recent period of time in the past based on a typical headway. As a preferred embodiment, the present invention considers the immediate previous six trips. Such designation helps account for trips within a 10-minute headway per hour.

Fourth, the database may be updated with the trip data that was recently extracted from the vehicle location record(s) S115.

Fifth, a most recent stop and at least one future stop on the trip data may be identified S120. Among all identified stops, at least one future stop would be the user's stop of interest. Generally, such stop of interest is predicated on the user's request.

Sixth, a link between the most recent stop and a first future stop, and where there are at least tow future stops, a link between each consecutive future stop, may be established S125.

“First future stop” means the very next or immediate stop along the vehicle's trip or route. In general, there is only one link between a first future stop and the most recent previous stop. If the most recent stop is a terminal stop, then the first future stop is the first immediate stop of a next trip, regardless of the vehicle's path, where the terminal stop becomes the next trip's origin.

Seventh, a travel distance for each of these separate links may be determined S130. If the vehicle has already departed from its most recent stop, the travel distance for the vehicle to the first future stop may be determined as the untraveled distance between the most recent position of the vehicle and the first future stop.

Eighth, a link travel time estimate corresponding to each link's travel distance may be determined S135. Generally, the link travel time estimate is the time it takes for the vehicle to travel the untraveled distance from the beginning of the link, along its path, to the end of the link. Each estimate may be determined using a weighted composite comprising the scheduled travel time for each stop along the trip, historical travel times of vehicles that have traversed the same trip, recent travel times of vehicles that have traversed the same trip, or a scalable, weighted combination thereof. As a preferred embodiment, this determination uses the mean (i.e., average) of the extracted historical travel times and the mean (i.e., average) of the extracted recent travel times.

Scalable, weighted combination of scheduled travel time/historical travel time/recent travel time comprises some percentage of the travel time estimate for each link of the trip. A preferred ratio is 20%/30%/50%, respectfully. However, other combinations may be used. Non-exhaustive examples, all of which are respectfully in a scheduled/historical/recent travel time ratio, include (1) about 30%/about 30%/about 40%; (2) about 15%/about 20%/about 65%; (3) about 25%/about 25%/about 50%; (4) about 20%/about 40%/about 40%; (5) about 45%/about 40%/about 15%; etc. It may be the case where one or two of these three elements may be at or about 0%.

As an example, consider the following. A scheduled travel time shows it takes approximately 8 minutes for a vehicle to travel a link (e.g., stop A to stop B). Historically, at approximately the same time for the past 30 days, it has taken approximately 9 minutes for the vehicle to travel this link. Recently, for the prior 6 trips, it has taken approximately 10 minutes for the vehicle to travel this link. Using a scalable weighted combination of 20% scheduled travel time, 30% of the historical travel time, and 50% of the recent travel time, the link travel time estimate for the vehicle to travel this link is 9.3 mins., which is the sum of (20% of 8 mins.=1.6 mins.), (30% of 9 mins.=2.7 mins.), and (50% of 10 mins.=5 mins.).

Ninth, the ETA for any future stop may be generated by cumulatively adding each link travel time estimate of each intervening future stop to a current time S140. The current time may be set or established by a host server, host computing device, or host computing network. For instance, where the vehicle has two future stops and future stop 2 is the stop of interest, link travel time estimate 1 for future stop 1 may be added to the current time to generate ETA 1. Link travel time estimate 2 for future stop 2 may be added to both link travel time estimate 1 and the current time to generate ETA 2.

Tenth, once the ETA for each future stop is generated, it may be uploaded into the database S145. The advantages of having the same database store generated ETAs include minimizing the amount of storage devices within the system and centralizing related data for archival purposes in one location. In addition, the database can help resolve the concern where ETA retrieval or transmission is not immediate, automatic, or both. The database may even help resolve the instance where ETA retrieval or transmission is interrupted or incomplete by allowing the generated ETA to be retrieved or transmitted again.

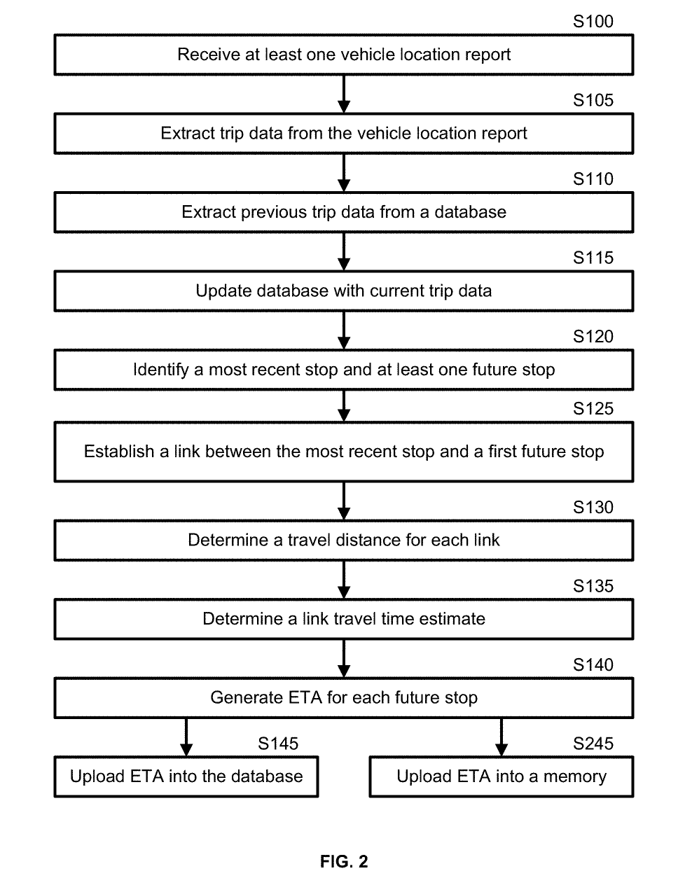

As an additional process and as indicated in FIG. 2, the ETA for each future stop along the trip may be uploaded into a memory, as a backup measure, and be temporarily stored there (such as up to when the vehicle arrives at the next immediate future stop) S245. Where there exists any fault with ETA retrieval or transmission from the database, uploaded ETAs for each stop may be retrieved from the memory as many times as requested until a configurable short period of time expires. Once the vehicle arrives at the next immediate stop, the ETA for such next immediate stop is no longer an estimate. Rather, it becomes the actual time of arrival, and the status of such next immediate stop is now converted into a current stop. When the vehicle departs from the current stop, the current stop's status converts into a previous stop. For any stop that has twice changed its status (i.e., next immediate to current, and current to previous or terminal stop), the generated ETA for that stop may be deleted from the memory.

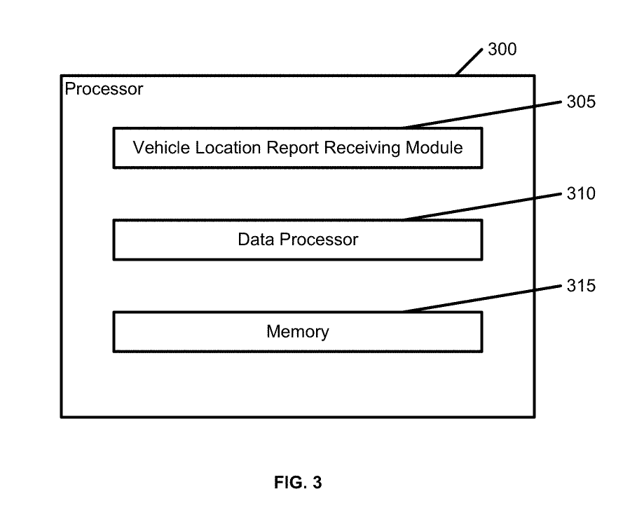

As the above methods and definitions are implementable by one or more processors 300 on a computing device or computing network, reference is now made to such processor 300. FIG. 3 shows the various physical modules that make up, and may be integrated within, processor 300 on a computing device. These modules include, but are not limited to, at least one vehicle location record receiving module 305; at least one data processor 310; and at least one memory 315.

Vehicle location record receiving module 305 may receive at least one vehicle location record at timed intervals. Each of these reports comprises static data and dynamic data. As previously mentioned, a preferred embodiment of a timed interval is at 30-second cycles. However, the processor may be configured to receive vehicle location records at other timed intervals (e.g., 10-second cycles, 15-second cycles, 45-second cycles, 1-minute cycles, 2-minute cycles, etc.).

Data processor (or a predictions module) 310 may provide for multifunction capabilities. A multifunctional data processor may extract trip data from a vehicle location record; extract previous trip data from a database; update the database with the trip data from recent vehicle location record(s); identify a most recent stop and at least one future stop corresponding to a trip based on the trip data; establish a link; determine a travel distance for each link; determine a link travel time; generate an ETA; and upload the ETA into a memory and/or database.

Previous trip data that is extracted from a database may include a scheduled travel time for each stop on a trip; historical travel times; and recent travel times.

Other data that may be extracted from the database include static data and dynamic data from previous vehicle location records, and associated static data from other sources. A non-limiting example of associated static data is look-up tables. These look-up tables may be premised on, or originate from, an interface (such as the New York City Transit Bus Customer Information System (CIS)) and/or other sources (such as the Metropolitan Transit Authority (MTA) operational data). The look-up tables may include data of scheduled travel time, trips, vehicle information, routes, etc.

A link may be established between the most recent stop and the first future stop. A link may also be established between each consecutive pair of future stops. If the most recent stop is a terminal stop, then the first future stop is the first immediate stop of a next trip.

For each link, whether it be between the most recent stop and the first future stop, or be between two future stops, a travel distance may be determined. Where the vehicle has already departed from its most recent stop along its trip, the untraveled distance is determined from the current position of said vehicle to the first future stop.

A link travel time estimate should correspond to the travel distance of a link. Generally, the travel distance of a link may be the distance between the two different stops. However, should the vehicle already be en route from the most recent stop to the first future stop, then the link travel time estimate for such remaining travel distance is the time it takes for the vehicle to travel the untraveled distance. In other words, the link travel time estimate may be estimated by multiplying the link travel time estimate by the ratio of the untraveled distance to the travel distance.

All link travel time estimates may be determined by using a weighted composite comprising the scheduled travel time of a stop; historical travel times; recent travel times; or a scalable, weighted combination thereof. As a preferred embodiment, the scheduled travel time is about 20% of the weighted composite. As a preferred embodiment, the historical travel time is about 30% of the weighted composite. As a preferred embodiment, the recent travel time is about 50% of the weighted composite. Thus, a configurable, weighted combination for scheduled travel time/historical travel time/recent travel time may be 20%/30%/50%, respectfully. However, as previously explained, other percentage combinations may be applied.

ETA may be generated for each future stop by cumulatively adding all of the intervening link travel time estimates to each future stop onto a current time.

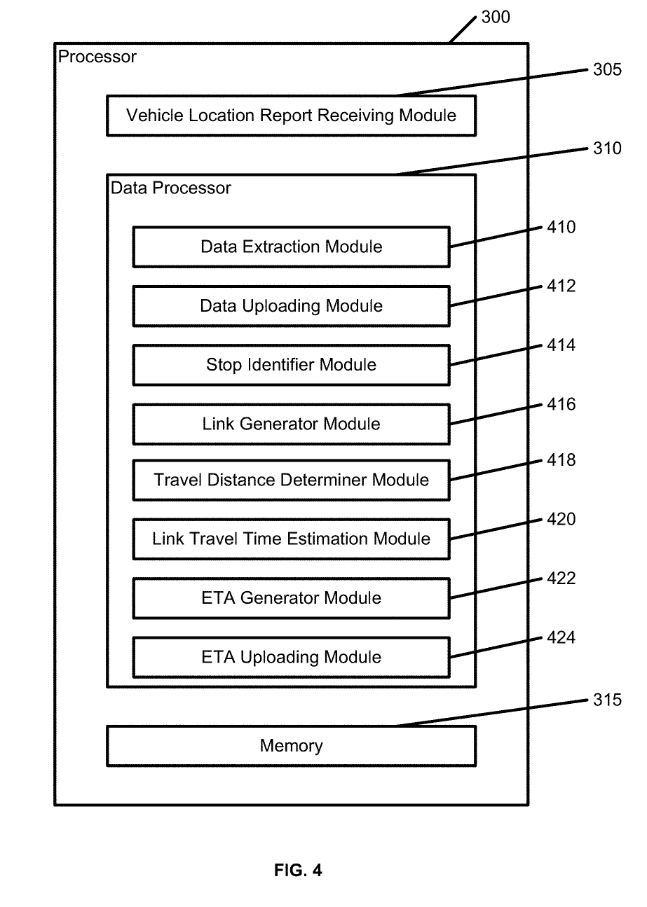

In yet another embodiment, as illustrated in FIG. 4, data processor (or a predictions module) 310 may integrate one or multiple hardware submodules for handling specific tasks. For instance, the submodules may include, but are not limited to, a data extraction module 410; a data uploading module 412; a stop identifier module 414; a link generator module 416; a travel distance determiner module 418; a link travel time estimation module 420; an ETA generator module 422; and an ETA uploading module 424.

Each of these subcomponents would handle the same or similar tasks as a multifunctional data processor.

Data extraction module 410 may extract data trip from a vehicle location record. The data extractor may also extract from a database the following previous trip data: a scheduled travel time for each stop on a trip; historical travel times; and recent travel times.

Data uploading module 412 may send or upload the trip data from recent vehicle location records into the database. The uploaded data may be used to update any or all of the data in the database.

Stop identifier module 414 may identify a vehicle's most recent stop and at least one future stop that corresponds to the trip based on the trip data.

Link generator module 416 may create links between the most recent stop and a first future stop. It may also establish links between future stops where there are two or more such stops along a trip based on the vehicle's current location.

Travel distance determiner module 418 may determine the travel distance of each link that is generated.

Link travel time estimation module 420 may determine the link travel time estimate that corresponds to each of the travel distances. To accomplish this feature, the link travel time estimator may use a weighted composite that comprises the scheduled travel time; historical travel times; recent travel times; or a scalable, weighted combination thereof. Where a vehicle has departed from its most recent stop and is on its way to a future stop, the link travel time estimator may determine the link travel time estimate to be the time it takes for said vehicle to travel the untraveled distance from the vehicle's current location to the future stop.

ETA generator module 422 may generate the ETA for each future stop by cumulatively adding all of the intervening link travel time estimates to each future stop onto a current time.

ETA uploading module 424 may upload ETA of each future stop into a memory and/or the database.

The memory 315 may temporarily store the ETA for later retrieval by a user command. The memory 315 may be configured to automatically delete the temporary storage of ETAs for particular stops after a certain time since a vehicle has departed from said particular stops.

Where the ETA is uploaded to the database, the database would continue to store the data until either the data is later updated, or the data expires after its configured short time.

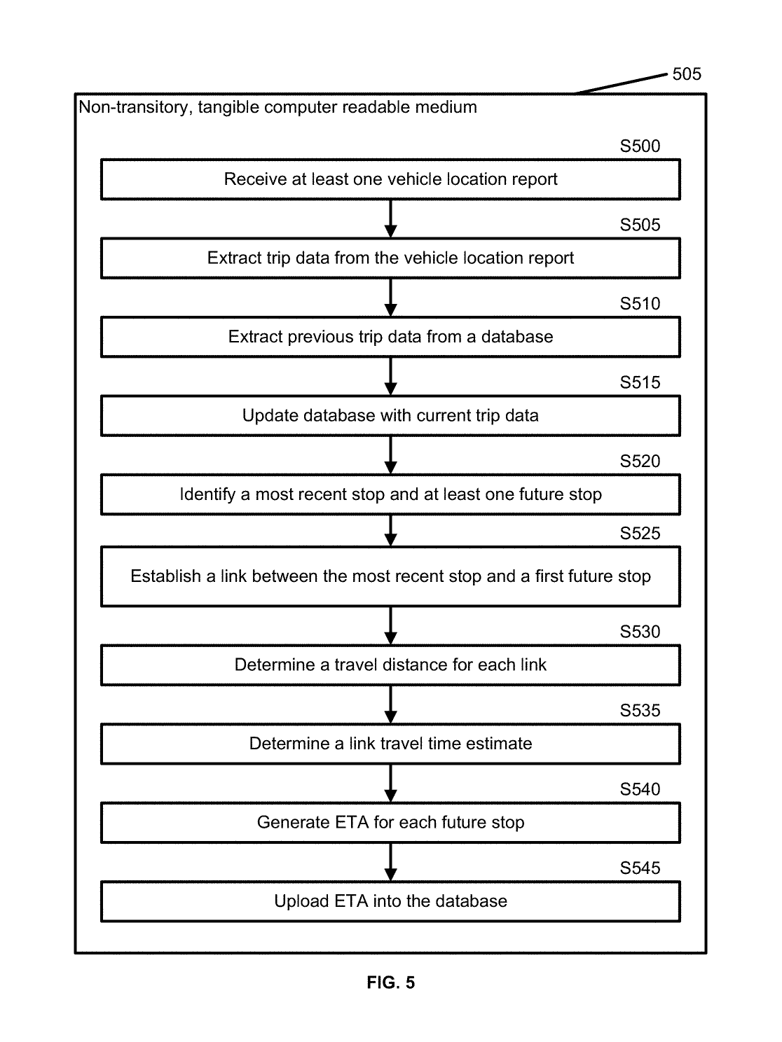

As the above methods (and the definitions which the above methods rely upon) can also be stored in a non-transitory, tangible computer readable storage medium 505, reference is now made to such storage medium. Referring to FIG. 5, the non-transitory, tangible computer readable storage medium 505 may store instructions for performing a method, when executed by at least one processor 310 on a computing device (such as a computer, smart phone, tablet, etc.), for determining the estimated time of arrival of a vehicle for a stop. The instructions for such method include: receiving at least one vehicle location record in timed intervals from said vehicle on trip via a processor 310 on a computing device S500; extracting trip data from said vehicle location record via said processor 310 on a computing device S505; extracting data from a database via said processor 310 on a computing device S510; updating said database with said trip data via said processor 310 on a computing device S515; identifying a most recent stop and at least one future stop corresponding to said trip based on said trip data via said processor 310 on a computing device S520; establishing a link via said processor 310 on a computing device between said most recent stop and a first future stop S525, and where there are at least two of said future stop, between each of said future stop; determining a travel distance for each of said link via said processor 310 on a computing device S530; determining a link travel time estimate, via said processor 310 on a computing device, wherein said link travel time estimate corresponds to each of said travel distance, by using a weighted composite S535; generating, via said processor 310 on a computing device, said ETA for each of said future stop by cumulatively adding said link travel time estimate of each said future stop to a current time S540; and uploading, via said processor 310 on a computing device, said ETA for each of said future stop into said database S545.

The first future stop may refer to the first immediate stop after the most current or recent stop or passed stop.

Data that is extracted from the database may include a scheduled travel time for each stop on said trip; historical travel times along said trip; and recent travel times along said trip.

Data or information uploaded into, or stored in, the database may be accessed or retrieved by the same processor on the computing device, or by another processor, server, computing device, etc.

The non-transitory, tangible computer readable storage medium 505 also accounts for scenarios where any vehicle has departed from the most recent stop and is traveling to the first future stop. In such scenarios, the travel distance for the vehicle is the untraveled distance between the current position of the vehicle and the first future stop. The link travel time estimate for such travel distance is the time it would be estimated to take for the vehicle to travel the untraveled distance.

The weighted composite may comprise said scheduled travel time; said historical travel times; said recent travel times; or a scalable, weighted combination thereof. About 20% of said weighed composite may be scheduled travel time. About 30% of said weighted composite may be historical travel time. About 50% of said weighted composite is said recent travel time. It should be noted that while these percentages represent a preferred embodiment, the non-transitory, tangible computer readable storage medium 505 may house instructions to allow for other combinations of percentages to be used as noted earlier.

### A. Vehicle Location Records

The present invention calculates link travel time estimates as a difference of arrival time between two stops. To accomplish this task, the present invention may first need to capture and store approximate historical arrival times and historical departure times from a stop. However, basing this calculation on this process alone may be complicated by certain factors. These factors may include (1) the somewhat limited granularity of vehicle location records; (2) counter-intuitive topology of portions of the network; (3) special considerations at the origin and destination terminals; and (4) fluctuations in GPS accuracy, in-revenue service, and inferences about a vehicle's current service (run/route).

The somewhat limited granularity of vehicle location records refers to where such records are being transmitted in intervals (such as only every 30 seconds, 1 minute, 2 minutes, etc.). Interval transmission may result in an individual vehicle location record not being generated, for whatever reason, with respect to a particular stop. For instance, there may be times where a vehicle may not be at a stop on a timed interval if emergency vehicles block the stop or first responders direct the vehicle to continue traveling. Thus, simply, there is no guarantee that there may be a record for transmission at any given stop.

Counter-intuitive topology of portions of the network refers to where some stops may be too close in proximity to each other to make distinct arrival and departure times meaningful. For instance, two different stops may be placed within 50 feet of each other. In reality, a bus along a trip arrives at the closer stop before arriving at the further stop. However, a counter-intuitive topology of the network would occur if the bus registers as having arrived at the further stop before departing from the closer one along its trip due to GPS inaccuracies.

Special considerations at the origin and destination terminals include, but are not limited to, adjustments made by dispatchers that tend to occur more frequently at terminal stops.

Fluctuations in GPS accuracy can cause errors derived from estimation reports, including, errors in association with a particular stop in areas where network topology is counter-intuitive.

In-revenue service and inferences about a vehicle's current service (run/route) refer to uncertainties as to whether a vehicle is on or will continue on its scheduled trip. Examples include, but are not limited to, vehicle accidents, operators running late and not logging into the system, emergencies affecting a vehicular scheduled route, etc.

To avoid these types of potential issues, data retrieved from vehicle location records should (1) occur in real time; (2) result in useful historical estimates of both stop arrival and departure times; (3) account for the network topography, transmission granularity, and/or GPS inaccuracies; (4) consider origin and terminal stops; and (5) handle edge cases in a graceful method.

The first two are self-explanatory. As for accounting for the network topography, transmission granularity, and/or GPS inaccuracies, it should be noted that there is a possibility that there may not be a precise vehicle location record at a particular given stop. This situation may arise because of the timed interval transmission. It may be the case where at the time of transmission, the vehicle is neither arriving nor departing from a stop.

However, it should be noted that transmissions at timed intervals may still be useful, such as enabling a user to track the location, direction, and/or velocity of the vehicle in 30-second intervals. As such, the present invention may be configured to incorporate either or both of two different ways of transmitting data from vehicle location records. One is timed-interval data transmission/recordation. The other is event-based data transmission/recordation whenever a vehicle arrives at or departs from the particular stop. If so, the present invention may either be configured to automatically switch, or permit an administrator to manually switch, between these types of data transmissions.

Gracefully handling edge cases include, but are not limited to, eliminating data points, data smoothing, and using previously obtained data from trips on the same or similarly planned or expected traveled route. This kind of handling matters when a vehicle falls into categories such as: (a) a vehicle is taken out of service; (b) a vehicle is placed into service in or during the middle of a trip; (c) a vehicle appears in an “impossible location;” or (d) any combination of these. “Impossible location” means no reasonable possibility or explanation on where a vehicle is said or told (e.g., by GPS, computer system, etc.) to be found. For instance, the vehicle is inside a building, or not located on or along a planned or expected traveled route, neighborhood, village, town, city, county, province, state, or country.

### B. Assumptions

The following assumptions and adjustments help provide a mechanism to account for the above-mentioned potentially problematic factors (e.g. counterintuitive network topology, GPS inaccuracies, etc.).

Generally, the present invention determines vehicles' ETAs based on a plurality of data: at least two vehicle location records; trip topology; other scheduled data; appropriate granularity, etc. The present invention is not designed to rely on any individual vehicle location record, or any single point of reference, because individual vehicle location records are typically undependable. They may never be received, or may include wrong, bad, or “impossible” data.

The terms “stop”, “at a stop,” “a particular stop,” “a given stop”, or “a particular given stop” refer to a range distance between a certain distance before the stop, denoted as (δ), and a certain distance after the stop, denoted as (ε). For example, if the stop is denoted as stop A, then the range distance that covers stop A is between δ_{A} and ε_{A}, or in other words, δ_{A}≦A≦ε_{A}. A vehicle may be considered to be at stop where the vehicle is within the range of δ_{A} and ε_{A}, or in other words, δ_{A}≦location of vehicle≦ε_{A}. A vehicle located or positioned within this range distance is at the stop, particular stop, given stop, or particular given stop.

Each δ value and each ε value may be configured and/or adjusted. As an aspect of the present invention, initial configuration for δ at stop A may be set at, for example, 50 meters. As another aspect of the present invention, initial configuration for ε at stop A may be set at, for example, 25 meters. Hence, in other words, δ_{A}=50 meters and ε_{A}=25 meters. Adjustment of each δ value and each ε value may be based on certain criteria, such as vehicle operator experience, test results, GPS fluctuations, real-world inaccuracies, traffic accidents, construction, road work, etc.

At a stop (for example, stop A again), the location of ε_{A} should not be permitted to pass the location of δ_{B}, where B, for example, is the subsequent stop (stop B). If this scenario were to occur, the distance of ε from stop A and the distance of δ from stop B should be proportionately reduced to provide a separation distance (or otherwise referred to as a minimum allowable distance) between them. In other words, there should be a minimum allowable distance (d) between ε_{A} (distance from stop A) and δ_{B}, (distance to stop B). Distance (d) is a configurable parameter that may be initially set to 1 meter and later changed, if desired or the change is needed. This distance (d) may not be less than δ_{A} (distance to stop A).

To maintain data integrity, the ETA at a stop (timeₐᵣᵣᵢᵥₐₗ) should not be more than the estimated departure time at the same stop (time_{departure}). That is, timeₐᵣᵣᵢᵥₐₗ≦time_{departure}, or alternatively, the estimated departure time at the stop cannot occur prior to the ETA of the same stop. However, they may be equal when the data do not permit the present invention to distinguish between arrival and departure times.

It is important to note that there may not be any prior stop in any of the following scenarios: (1) the vehicle is at the origin (i.e., origin stop); (2) the vehicle is inferred to be starting or traveling on a new trip; or (3) the vehicle is inserted into a stopping pattern in the middle or during its current trip.

It is also important to note that at the vehicle's final stop (i.e., terminal stop), neither an ETA nor an estimated stop departure time is necessary or required since passengers are unlikely to be waiting at this stop. However, when possible, each or both may be calculated and may be stored in the database.

In the instance where a vehicle appears to be traveling backwards or has traveled backwards, any data obtained with respect to any backwards movement should be ignored and/or discarded to maintain data integrity. Backwards traveling may be considered as an example of “impossible” data or “impossible location.”

As noted earlier, each vehicle location record includes a time element (such as a timestamp). In determining the departure time for a vehicle from a previous stop, the present invention may designate a maximum allowable time (t) to lapse for when the next vehicle location record must be transmitted or recorded since the transmission or recordation of the last vehicle location record in order to treat all previous calculations as usable for the current trip. If the time exceeds (t), the present invention does not calculate a departure time for the previous stop and presumes that all data received after (t) represents a newly inserted trip. This time (t) is a configurable parameter, such as being set to 3 minutes, and may be adjusted as needed. Reasons for such presumption include, but are not limited to, a newly inserted trip, a long delay that may throw off estimates (and potentially by an unacceptable margin), etc.

### C. ETA Scenarios

1. Scenario 1: One Vehicle Location Record is Considered “At The Stop” for a Single Stop

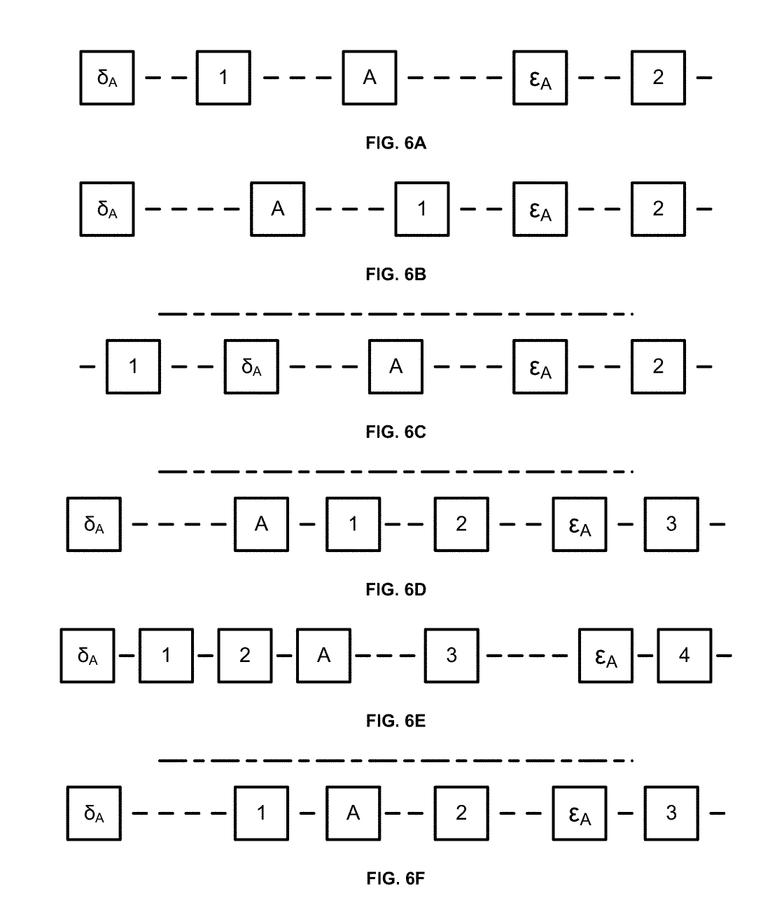

When this case occurs, the timestamp of the first vehicle location record that is considered “at the stop” may be assigned as the ETA for that stop. Examples are shown in FIG. 6A and FIG. 6B, where the ETA may be set to the timestamp of vehicle location record 1. Such setting may apply even when the vehicle location record shows the vehicle is physically after the stop but within ε. Additional records are unnecessary to assign an arrival time.

It should be noted that δ and ε at consecutive stops under this scenario are not likely close enough to overlap each other.

For these figures, as well as subsequent figures having a similar schematic diagram layout, the numbers shown indicate the order of the vehicle location record as received. The letters indicate a regular stop along the trip and are ordered in the sequence in which they occur. T represents the terminal stop on the trip.

2. Scenario 2: One or More Vehicle Location Records Before and After The Stop But Not “At The Stop”

There are no vehicle location records indicating that a vehicle is “at the stop,” but there exists at least one vehicle location record before and at least one after the stop. Under such circumstances, ETA at a stop may be determined using data from (1) the last vehicle location record received prior to the stop; (2) the first vehicle location record received after the stop; and (3) the location of the stop.

Referring to FIG. 6C, ETA may be set to a linear interpolation of the time at the location of the stop using the times and locations of vehicle location record 1 and/or vehicle location record 2.

This scenario accounts for situations when one or more vehicle location records are unreliable. For instance, a vehicle location record may not be transmitted, for whatever reason (e.g., vehicle passed the stop without stopping, malfunctioning record transmitter aboard a vehicle, system maintenance interruption, etc.). Also, there remains the uncertainty of whether any new vehicle location record would be received after the most recent one but before the vehicle arrives at the stop. Hence, as a preferred embodiment, except when the vehicle approaches the terminal stop, the present invention may be configured to retain data from the most recent vehicle location record at each interval along the trip prior to being at the stop, until superseded by another vehicle location record prior to the stop.

It should be noted that, like above, δ and ε at consecutive stops under this scenario are not likely close enough to overlap each other. A reason is since the present invention is likely to receive multiple vehicle location records, each of which are further along the link, without yet reaching the next stop, δ and ε are unlikely to be that close.

3. Scenario 3: Multiple Vehicle Location Records are Considered “At The Stop” for a Single Stop

Here, there are multiple vehicle location records that are considered “at the stop” for a single stop. For instance, the vehicle may remain “at the stop” for a considerable duration of time such that multiple vehicle location records are generated during that time. When this scenario occurs, the timestamp of the first vehicle location record that is considered “at the stop” may be assigned as the ETA for the stop.

Examples of this scenario may be seen in FIG. 6D and FIG. 6E. The ETA may be set to the timestamp of vehicle location record 1. Like scenario 1, such setting may apply even when the vehicle location record shows the vehicle is physically after the stop but within ε. Additional records are unnecessary to assign an ETA.

It should also be noted that δ and ε at consecutive stops under this scenario are not likely close enough to overlap each other.

### D. Estimated Departure Time Scenarios for a Stop

For each of the following scenarios under this category, if the system using or incorporating the present invention receives a vehicle location record older than (t) minutes from an unprocessed vehicle location record for an ETA, the system is not likely to calculate any departure time. Hence, under such case, there may not be any travel time generated for any unprocessed upstream link(s). Otherwise, departure time would likely be calculated, and travel time would likely be generated.

1. Scenario 1: The System Receives Only One Vehicle Location Record “At The Stop” and Another Vehicle Location Record “After The Stop”

Departure time may be determined as the time when the vehicle is at or after c, where the vehicle is no longer “at the stop.” Such determination helps maintain data integrity, where timeₐᵣᵣᵢᵥₐₗ≦time_{departure}.

To estimate the departure time at the stop, one may use a linear interpolation of the vehicle's locations and timestamps of at least two records. For example, as illustrated in FIG. 6A and FIG. 6B, one of these records (e.g., vehicle location record 1) may be before c, while another record (e.g., vehicle location record 2) may be after ε. The vehicle's locations and timestamps from these records may be used to estimate the time at ε_{A}, which is the estimated departure time at stop A.

It should be noted that δ and ε at consecutive stops under this scenario are not likely close enough to overlap each other.

2. Scenario 2: The System Receives Multiple Vehicle Location Records “At The Stop”

The departure time may be determined from a linear interpolation using the location and timestamp of the last vehicle location record “at the stop” and the location and timestamp of the first vehicle location record that is immediately “after the stop.”

As exemplified in FIG. 6F, the locations and timestamps of vehicle location record 2 and vehicle location 3 may be used to estimate the time at ε_{A}, which is the estimated departure time at stop A.

3. Scenario 3: No Vehicle Location Record That is Considered “At The Stop” But There is One or More Vehicle Location Records Before and After The Stop

Under these circumstances, the departure time may be set to a linear interpolation on using the last received vehicle location record that is located prior to δ of stop A (δ_{A}) and the vehicle location record immediately after ε of stop A (ε_{A}).

Referring to FIG. 6C, the location and timestamp data collected from vehicle location record 1 and vehicle location record 2 may be used to estimate the stop departure time at ε_{A}, which is the estimated departure time at stop A.

### E. Exception Scenario—δ and ε Overlap at a Non-Terminal Stop

Occasionally, schedule data (whether scheduled travel times or scheduled arrival times) may include stops that are very close to each other, but greater than distance d. When this situation occurs, the system may, in some iterations, interpret vehicle location records so as to conclude that the vehicle is simultaneously located at multiple stops (i.e., the vehicle may appear to be within δ and ε of multiple stops). As such, there may be a risk that the vehicle's departure time at the first stop would be estimated as a time after the vehicle arrives at the second stop. Thus, constraints are deemed to be violated.

As a way to correct this violation, when the location of ε for any non-terminal stop occurs after the location of δ for any subsequent stop, the system is likely to change the locations of δ and ε. In other words, the system may relocate ε and δ (i.e., switch their positions) to maintain a minimum separation of d from each other and their respective stops. In essence, δ and ε may be moved equidistant from the surrounding stops and may be separated by d. Thereafter, the system may calculate ETA(s) and estimated stop departure time(s) using procedures as described earlier.

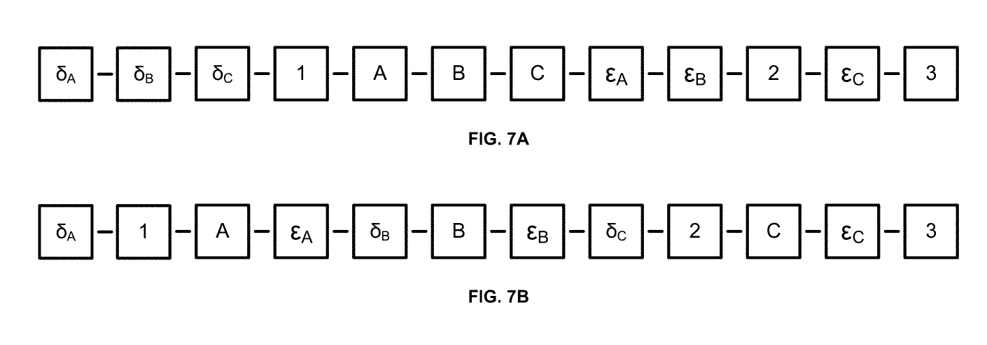

Referring to FIG. 7A, a vehicle location record may be transmitted after δ_{A}, δ_{B}, and δ_{C} but before ε_{A}. In this example, there are three stops (A, B, and C) that are very close to each other. Assume δ=ε. Vehicle location record 1 is considered “at the stop” for all three stops.

Based on this exemplified scenario, the system may change the values of δ and ε, as illustrated in FIG. 7B, so that δ_{A} and ε_{A} do not overlap with either δ_{B} and ε_{B}, or δ_{C} and ε_{C}. δ_{A}, ε_{C}, and the location of all three stops A, B, and C remain the same. ε_{A} may be moved to (½ distance between A and B)−d/2. δ_{B} may be moved to (½ distance between A and B)+d/2. ε_{B} may be moved to (½ distance between B and C)−d/2. δ_{C} may be moved to (½ distance between B and C)+d/2. Once modified, the ETA(s) and estimated stop departure time(s) may determined using the above described procedures.

However, there may be occasions that may prevent the above value changes from taking place. One is where the distance between ε and δ cannot be modified so as to maintain the minimum separation of d between each ε and each δ. Another is where changing the values would create ETA(s) and/or estimated stop departure time(s) that fall outside the scope of the above constraints. When either of these occur, the system should not be expected to calculate the ETA(s) or estimated stop departure time(s) for these stops.

### F. Terminal Stop

1. Arrival at the Destination Terminal Stop

As a vehicle approaches a terminal stop (T), the vehicle's trip or trajectory may change. Rather than waiting for another vehicle location record to be transmitted when the vehicle is within δ_{T}, the system may modify δ_{T} by extending its distance. For instance, where δ_{T} is approximately 50 meters, the system may double this distance and make δ_{T}=100 meters. Extending δ_{T} may help accommodate scenarios where the vehicle ends further away from T or where T is very close to the origin of the vehicle's next trip.

For instance, consider bus transportation to a convention center. Many buses that follow others into a convention center may not end up at the main entrance. Rather, they may end up stopping a certain distance behind, in front of, or adjacent to other buses and vehicles, but yet relative near the main entrance to be deemed at the terminal stop.

To determine the ETA, the system may use the first vehicle location record that may consider the vehicle “at the stop” for T. Making this adjustment helps the system complete the processing of the vehicle's current run, trip, and direction. Additional criteria for such adjustment may also need to be considered. Examples include, but are not limited to, whether an upstream stop requires further processing, and whether δ_{T} overlaps with ε of any prior stops.

a) Scenario 1: All Upstream Stops Have Been Assigned Departure Times

This scenario represents the vast majority all situations.

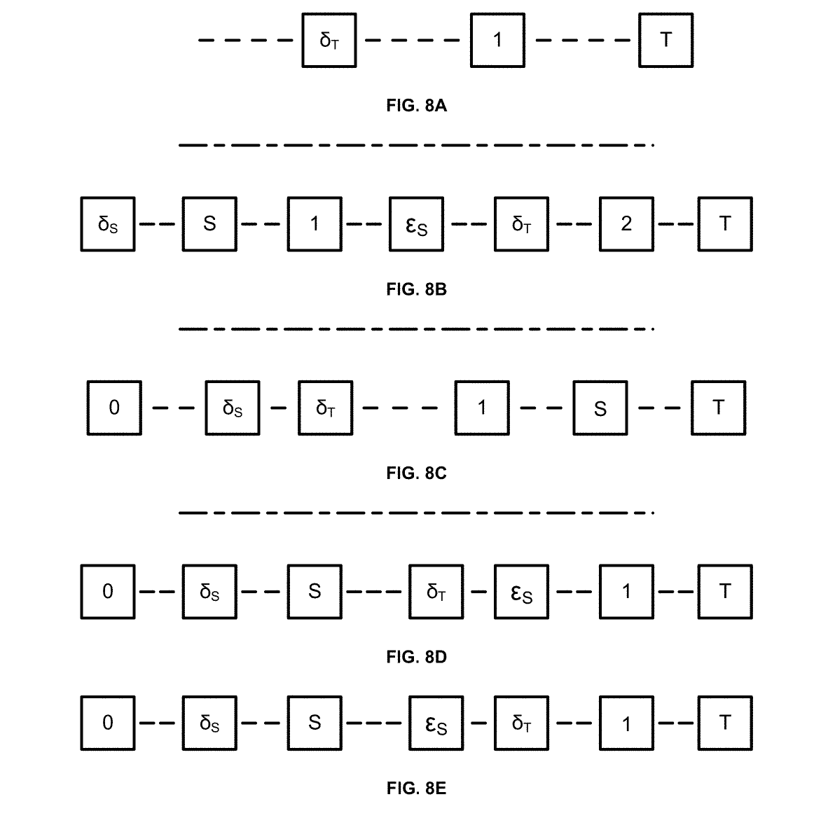

The ETA for δ_{T} may be assigned as the timestamp of the current vehicle location record. For example, referring to FIG. 8A, the ETA at terminal stop T may be set to the time indicated in vehicle location record 1.

b) Scenario 2: One Non-Terminal Stop Without a Completed Departure Time; The Current Vehicle Location Record is Received “At The Terminal”

In this example, stop S may be close to terminal stop T. However, ε_{S} does not overlap δ_{T}. The arrival time at stop S should have already been recorded. The estimated stop departure time should be interpolated for S. The ETA for terminal stop T may be determined using the current timestamp of the received vehicle location record.

Referring to FIG. 8B, ε_{S} may be calculated from the interpolation of the timestamp at vehicle location record 1 and vehicle location record 2. The ETA at terminal stop T may be set to the timestamp at vehicle location record 2.

c) Exception Scenario: One or More Regular Stops (A, B, C, etc.) Within δ_{T}

Generally, when δ of any stop is set appropriately, the granularity of data may not be sufficiently detailed to determine ETAs and estimated stop departure times. As such, any stop past δ_{T} should be ignored.

In cases where ε_{S} is past δ_{T}, ε_{S} may be set to the current position of δ_{T}. Furthermore, δ_{T} may be set to δ_{T}+a configurable minimum distance of separation. The configurable minimum distance of separation (whether it be 0 feet, 25 feet, or 60 feet) is based on user experience.

Referring to FIG. 8C as one example, where stop S and terminal stop T are close together, stop S should be ignored, and the ETA at T (based on vehicle location record 1) should be recorded.

Referring to FIG. 8D as another example, stop S and terminal stop T are close together such that δ_{T} is less than ε_{S}. This case may be corrected by having δ_{T}=ε_{S} and δ_{T}=δ_{T}+d, which results in the sequence as illustrated in FIG. 8E. Subsequently, using vehicle location record 1 as the basis, the ETA at the terminal stop T may be recorded.

2. Departure at the Destination Terminal Stop

In an embodiment, a departure time for a destination terminal may be set to NULL.

3. The Origin Stop

The following considers the vehicle returning back from terminal stop T to the point of origin.

a) Arrival Time of the Origin Stop

In an embodiment, an arrival time for an origin stop may be set to NULL.

b) Departure Time of the Origin Stop

As an embodiment, ε of the origin may be modified (such as from 25 meters from the origin to 150 meters from the origin) to account for any trip that may have begun further away from the terminal due to potentially inaccurate layover inferences while the vehicle is still near the origin.

1) Standard Case: No δ Points Occur Before ε_{T}

The departure time from the origin may be an interpolation of the timestamp for the last vehicle location record at origin stop T, and the first vehicle location record past T, which may be interpolated to location ε for T.

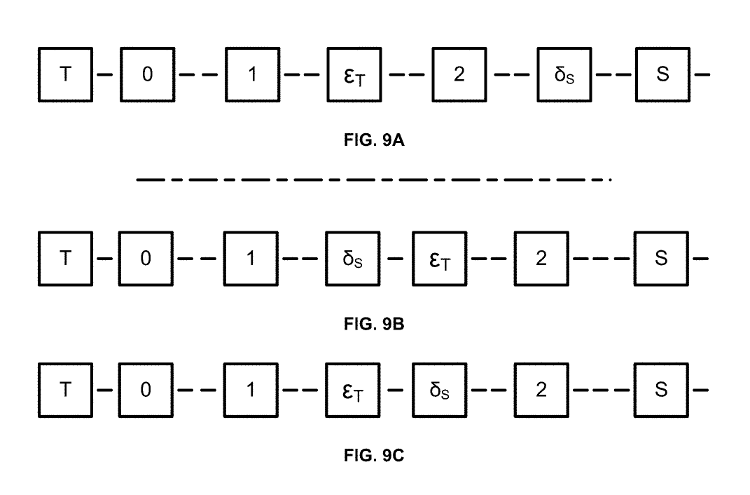

Referring to FIG. 9A, with arrival time for T set to NULL, vehicle location record 1 and vehicle location record 2 may be interpolated to calculate the estimated stop departure time from T.

2) Exception Case: One or More δ Points Occur Before ET

Similar to the exception case of terminal stops, any stop that has a distance along the trip that occurs prior to ε_{T} may be ignored.

Referring to FIG. 9B, there may be one or more occasions where δ_{S} of stop S (e.g., the first stop) occurs prior to ε_{T}. To correct such case, δ_{S} may be set to ε_{T}, and ε_{T} may be set to ε_{T}−minimum distance of separation, as illustrated in FIG. 9C. Vehicle location record 1 and vehicle location record 2 may be interpolated to calculate the estimated stop departure time from T. Stop S may be processed accordingly with the ETA being set to the timestamp of vehicle location record 2.

### G. Arrival and Departure Workflow

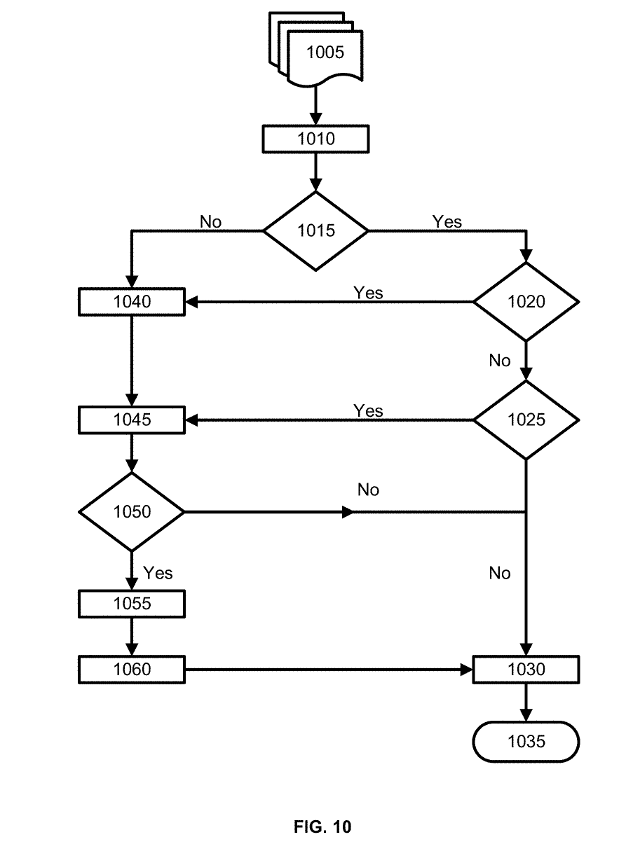

As an embodiment of the present invention, FIG. 10 shows a workflow example for determining ETA and estimated stop departure time.

From a post-inference queue 1005 from an inference engine in an AVL system, the system may take and load the vehicle location record using its unique identifier (i.e., a key) from the cache 1010. The system then determines whether the vehicle in question has a valid, previously (within a configured short (expiration) time) cached vehicle location record 1015. If not, the system may clear the relevant stops queue of everything 1040. If there is at least one such valid record, the system may next populate the relevant stops queue with stops after greatest epsilon of the last arrived stop (if possible) and any stop within the distance of a stop 1045. Afterwards, the system determines whether there are any relevant stops in the stop queue 1050. If no, the system updates the information (time, location, etc.) in the vehicle cache 1030. If yes, for any relevant stop in the queue that should have an arrival time or departure time set, the system may set this time now 1055. Thereafter, the system persists (i.e., remembers or stores) any stop arrival or departure times in the relevant stops queue 1060. Following up, the system updates the information (time, location, etc.) in the vehicle cache 1030. Once updated, processing may end 1035.

Where the vehicle has a valid, previously cached vehicle location record, the system determines whether the trip has changed; whether the record is old (i.e., a configurable amount of time has elapsed without receiving expected vehicle location records and it creates some uncertainty on the use of the data); and whether the vehicle has moved impossibly far (i.e., physically impossible) 1020. If any of the conditions is affirmative, the system clears the relevant stops queue 1040 and proceeds with the above described workflow. If all the conditions are negative, the system then determines whether the vehicle has moved forward 1025. Where a vehicle has moved forward, the system proceeds with the population procedures 1045 in the above described workflow. Where a vehicle has not moved forward, the system updates the information (time, location, etc.) in the vehicle cache 1030.

### H. Predictions Module

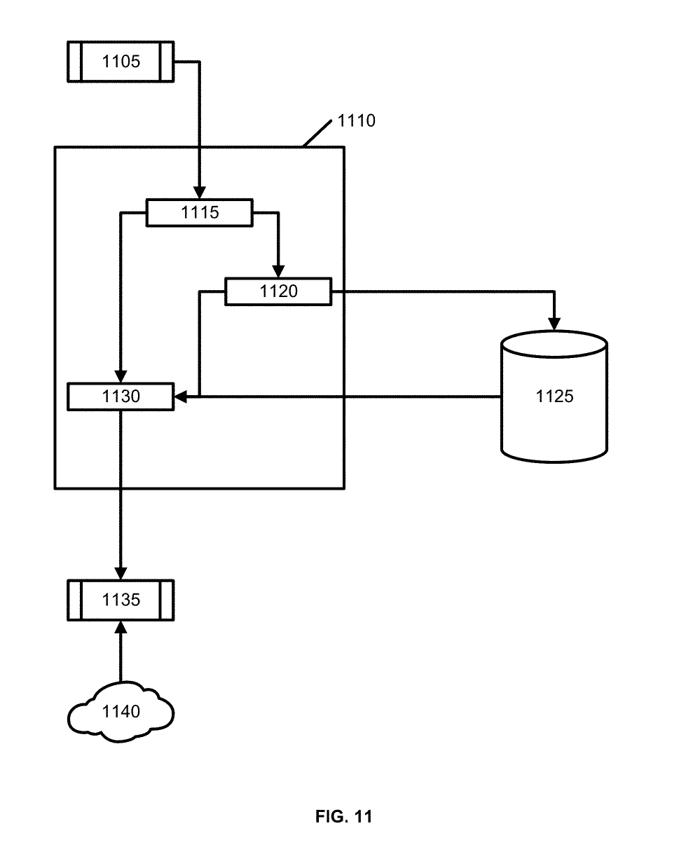

This workflow may be embodied in a system such as the one shown in FIG. 11, which provides another perspective of the incorporation of elements as displayed in FIG. 1 to FIG. 5, and FIG. 10.

Taking data from a post-inference queue 1105, a system may send the acquired data into a predictions module 1110 (such as the OneBusAway-New York City (OBA-NYC) predictions module) that includes at least one core library. Using data federation tools 1115, such as SAS Federation Server, the system extracts, aggregates, and transforms the data for analysis.

This data may be forwarded to both a lattice 1120 and a prognosticator 1130. The lattice 1120 may convert and decode the data into estimated link travel times, store link travel times, and aggregated link travel times. Using an internal Java interface, the lattice 1120 may forward estimated link travel times may be forwarded to a prognosticator 1130. As for the written link travel times and aggregated link travel times, the lattice 1120 may forward these to a database 1125 located outside the predictions module. As one embodiment, the database 1125 is a MongoDB Database, and the channel for data transfer to the MongoDB Database is a Spring Mongo library. In turn, after the database 1125 has stored these data, the database 1125 may transfer the aggregated link travel times back to the predictions module 1110 and into the prognosticator 1130.

The prognosticator 1130 is the central component (whether a processor or submodule of the predictions model) that takes data from the data federation 1115, lattice 1120, and database 1125. When the prognosticator 1130 analyzes the combined received data, the prognosticator 1130 may use a feed specification (such as the General Transit Feed Specification-Real-time (GTFS-RT)) and/or a debugging program via a queue manager such as ZeroMQ to convert the data into readable data and forward the converted data to a predictions queue 1135 (such as OBA-NYC Predictions Queue), which may have at least one input port and at least one output port. It should be noted that all ports are preferably configurable. Debugging messages are also preferably configurable, via either XML configuration hooks and/or TDM configuration variables. Once stored in the predictions queue 1135, a predictions queue subscriber 1140 can extract (i.e., pull) the converted data from the system at any time.

### I. Examples

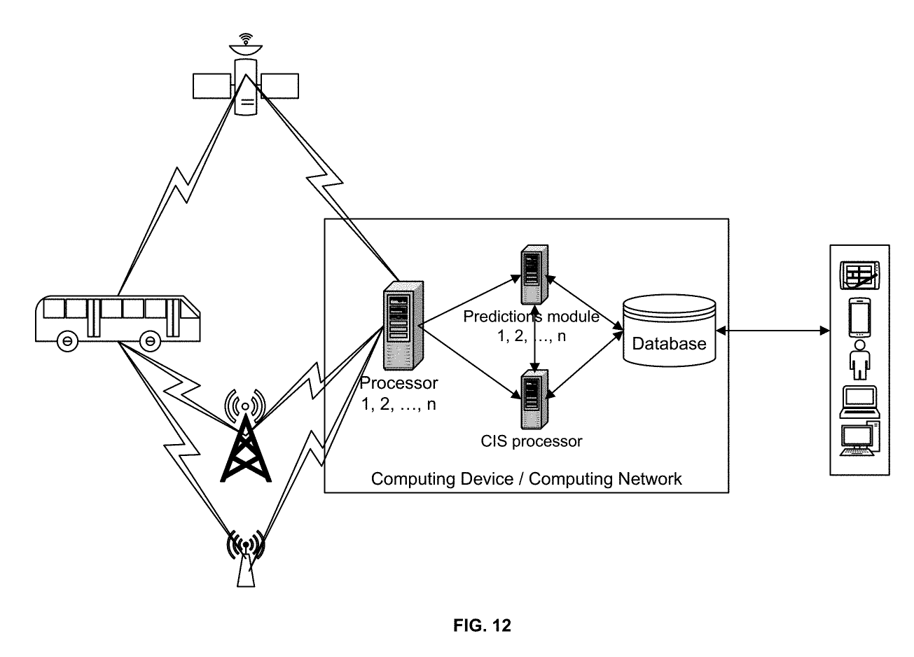

Referring to FIG. 12, the present invention may be placed into operation involving, for example, a public transportation bus on a trip along a route. By communicating via satellite or towers, or even connecting via wireless access points, the bus may send vehicle location records from its trip to one or more processors on a computing device or in a computing network that generates ETAs and estimated departure times at one or more bus stops.

In turn, one or more processors may extract trip data from the vehicle location records. Extracted trip data may be forwarded to one or more predictions module. While each module(s) may be configured to extract from a database a scheduled travel time, historical travel times, and recent travel times for each stop corresponding to the bus' trip, the predictions module(s) may also be configured to update the database with the most recent acquired trip data.

Furthermore, each of the prediction module(s) may be configured to identify the most recent stop and at least one future stop corresponding to the trip based on the current and most recent trip data. Such configuration helps maximizes efficiency by curtailing unnecessary calculations with respect to multiple past stops.

With stops identified, the prediction module(s) may establish a link between the most recent stop and a first future stop. Alternatively, the prediction module(s) may establish a link between future stops where there are two or more future stops. For each established link, the prediction module(s) may determine a travel distance and a corresponding link travel time estimate using a weighted composite. The weighted composite may comprise the scheduled travel time from the database, historical travel times from the database, recent travel times from the database, or a scalable weighted combination of any of these three types of times.

The predictions module(s) may then generate an ETA (or even an estimated departure time) for each future stop by aggregating the link travel time estimates. Afterwards, the predictions module(s) may upload each ETA (or estimated departure time) into the database or a memory. When a user sends a request for ETAs or estimated departure times via, for example, a mobile device (e.g., cell phone, smartphone, laptop, tablet, etc.) or a computer, the present invention allows for the user's device to extract the requested ETAs and/or estimated departure times from the database or a memory.

Alternatively, after the processor extracts trip data from vehicle location records, the processor may forward static data to a Customer Information Systems (CIS) processor and dynamic data to one or more predictions module(s). Based on the bus' current location, the CIS processor may forward relevant data to the predictions module(s) and update the database as necessary. In turn, the predictions module(s) may take the data forwarded by the CIS processor to ultimately generate ETAs and estimated departure times. The predictions module(s) may forward these times to either the CIS processor (which in turn may forward it to the database), or directly to the database for extraction by a user. An advantage of having the CIS processor receiving these times is having the CIS processor communicating back to the bus via satellite or towers, or even wireless access points, to a visual display on the bus to alert any onboard customers of the bus' next stop, ETA, estimated departure time, etc.

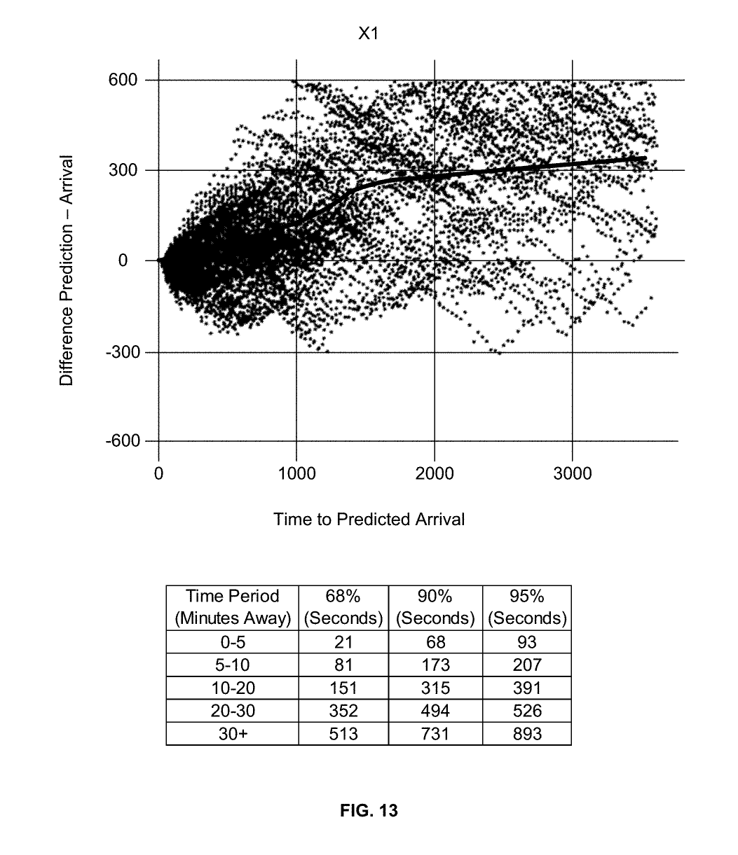

The present invention was tested on multiple MTA-NYCT Bus lines. Referring to FIG. 13 to FIG. 18, graphical representations of results from multiple experimentations are shown. The bus lines tested are, respectively, X1, M15-SBS, M34A-SBS, B63, S40, and S79-SBS. Each of these routes were tested for approximately 30 minutes. All were tested in the morning. Specifically, tests on the X1 began at about 9:00 AM. Tests on the M15-SBS begin at about 9:30 AM. Tests on the M34A-SBS began at about 10:00 AM. Tests on the B63 began at about 10:30 AM. Tests on the S40 began at about 11:00 AM. Tests on the S79-SBS began at about 11:30 AM.

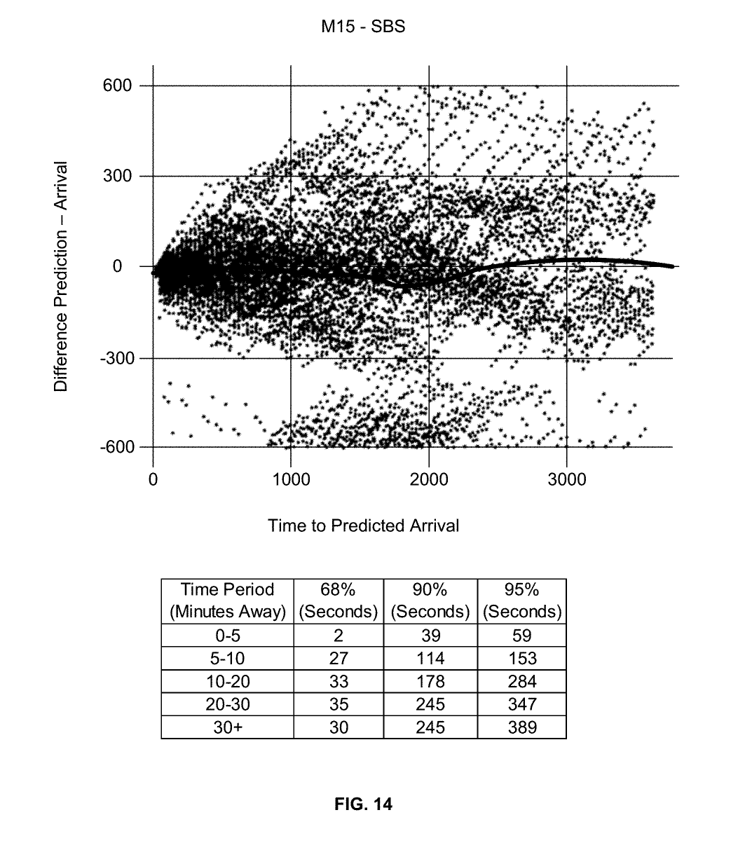

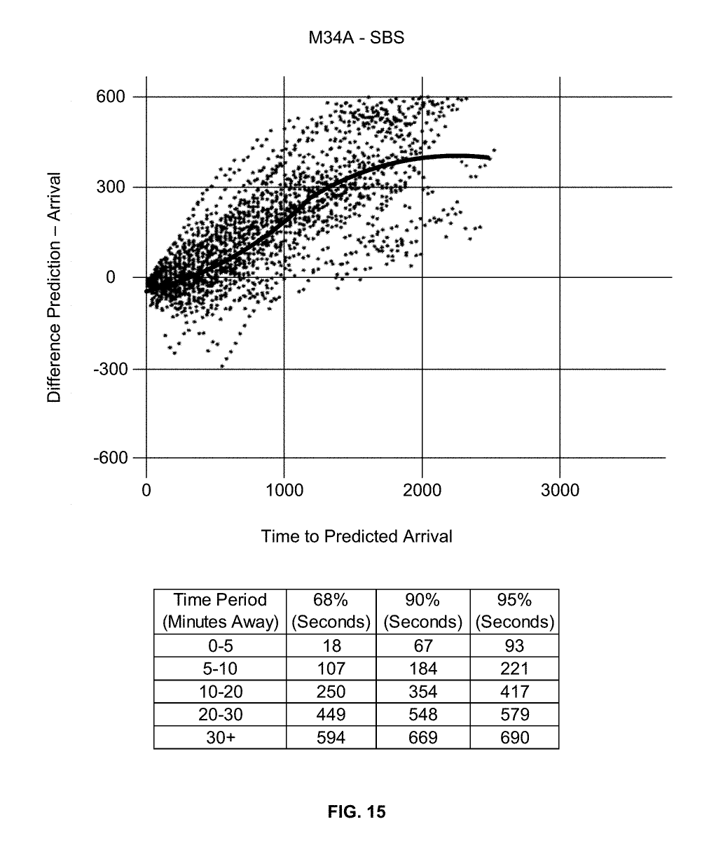

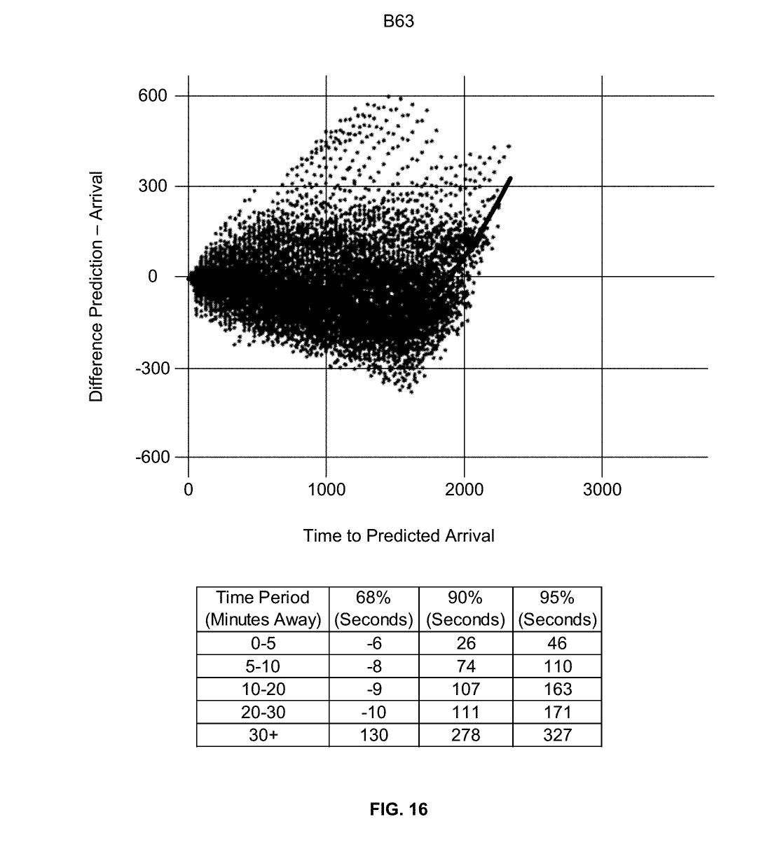

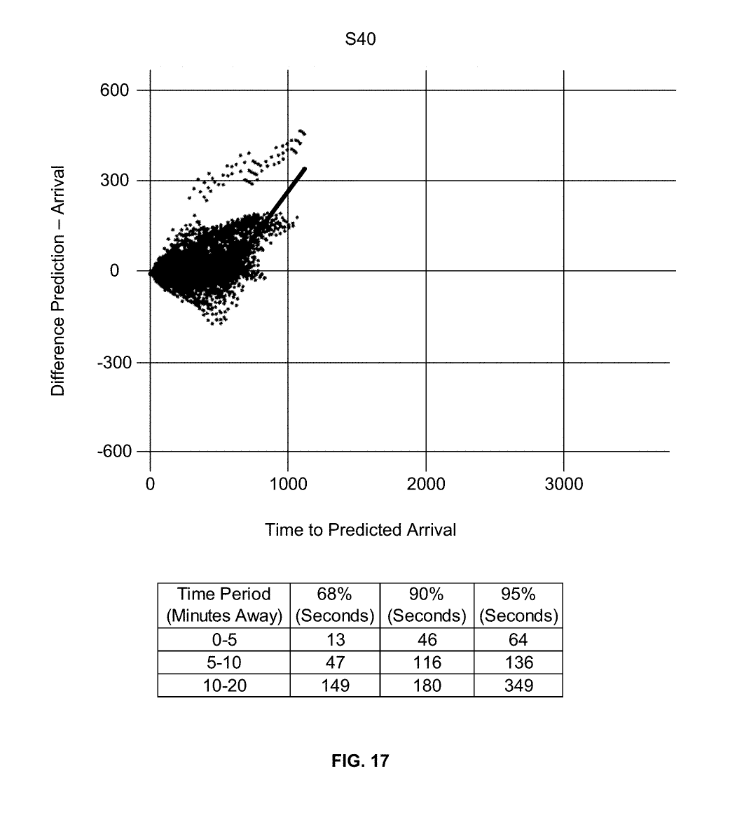

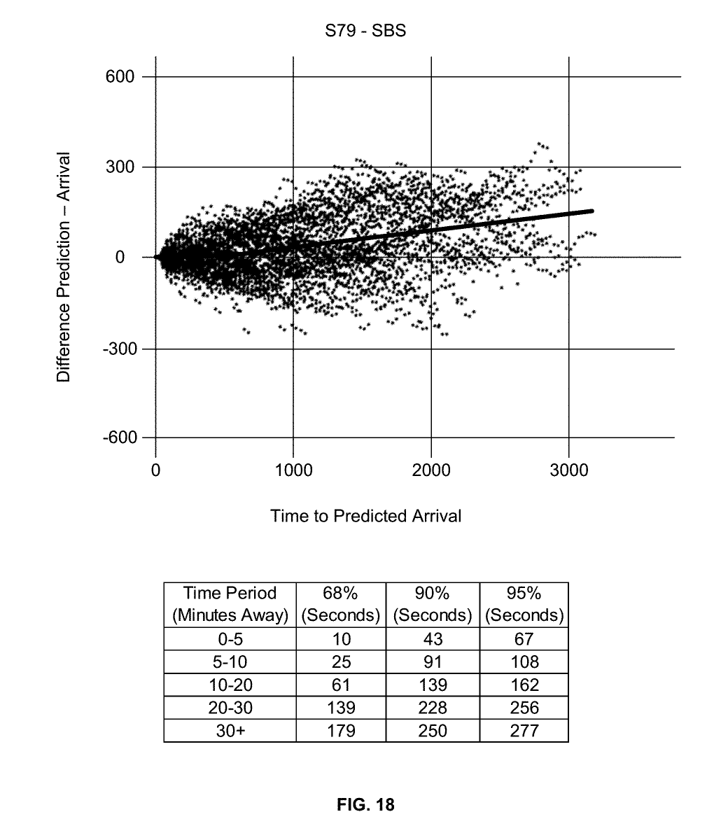

For each of these figures, there is an accompanying result table for tests showing a time period and an accuracy rate. The time period column shows a range of how many minutes away the bus was from the next stop. The other three columns (namely, 68%, 90%, and 95%) show what percentage of the time that the bus arrived within the number of seconds shown as predicted. For example, in FIG. 13, if the X1 bus will arrive in 0-5 minutes, 90% of the time it will arrive within 68 seconds of the time that was predicted. In FIG. 14, if the M15-SBS bus will arrive in 5-10 minutes, 68% of the time it will arrive within 27 seconds of the time that was predicted. In FIG. 15, if the M34A-SBS will arrive in 10-20 minutes, 95% of the time it will arrive within 417 seconds of the time that was predicted. In FIG. 16, if the B63 bus will arrive in 20-30 minutes, 68% of the time it will arrive within 10 seconds earlier of the time that was predicted. In FIG. 17, if the S40 bus will arrive in 0-5 minutes, 95% of the time it will arrive within 64 seconds of the time that was predicted. In FIG. 18, if the S79-SBS bus will arrive in 5-10 minutes, 90% of the time it will arrive within 91 seconds of the time that was predicted.

### J. Considerations

In this specification, “a” and “an” and similar phrases are to be interpreted as “at least one” and “one or more.”

Many of the elements described in the disclosed embodiments may be implemented as modules. A module is defined here as an isolatable element that performs one or more defined functions and has a defined interface to other elements. The modules described in this disclosure may be implemented in hardware, software, firmware, wetware (i.e. hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of estimating the arrival time of a vehicle at a stop. However, one skilled in the art will recognize that embodiments of the invention may be used to estimate the departure time of a vehicle at a stop. For example, one who may be in a hurry to get to a particular destination may want to know how long it will take for a vehicle to leave a particular stop after it arrives at the stop.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What are claimed are:

1. A method for determining the estimated time of arrival of a vehicle at a stop, said method comprising:
a. receiving at least one vehicle location record in timed intervals from said vehicle on trip via a processor on a computing device;
b. extracting trip data from said vehicle location record via said processor on a computing device;
c. extracting previous trip data from a database via a processor on a computing device, the previous trip data comprising:
i. a scheduled travel time for each stop on said trip;
ii. historical travel times; and
iii. recent travel times;
d. updating said database with said trip data via said processor on a computing device;
e. identifying a most recent stop and at least one future stop corresponding to said trip based on said trip data via said processor on a computing device;
f. establishing a link via said processor on a computing device:
i. between said most recent stop and a first future stop; and
ii. where there are at least two of said future stop, between each of said future stop;
g. determining a travel distance for each of said link via said processor on a computing device;
h. determining a link travel time estimate, via said processor on a computing device, wherein said link travel time estimate corresponds to each of said travel distance, by using a weighted composite comprising:
i. said scheduled travel time;
ii. said historical travel times;
iii. said recent travel times; or
iv. a scalable, weighted combination thereof;
i. generating, via said processor on a computing device, said ETA for each of said future stop by cumulatively adding said link travel time estimate of each said future stop to a current time; and
j. uploading, via said processor on a computing device, said ETA for each of said future stop into said database for retrieval.

2. The method according to claim 1, further including uploading, via said processor on a computing device, said ETA for each of said future stop into a memory.

3. The method according to claim 1, wherein said travel distance for said vehicle that has departed said most recent stop is the untraveled distance between the current position of said vehicle and said first future stop.

4. The method according to claim 3, wherein said link travel time estimate for said travel distance is the time it takes for said vehicle to travel said untraveled distance.

5. The method according to claim 1, wherein said scheduled travel time is about 20% of said weighted composite.

6. The method according to claim 1, wherein said historical travel time is about 30% of said weighted composite.

7. The method according to claim 1, wherein said recent travel time is about 50% of said weighted composite.

8. The method according to claim 1, wherein if said most recent stop is a terminal stop, then said first future stop is the first immediate stop of a next trip.

9. A processor on a computing device configured for determining a vehicle's estimated time of arrival comprising:
a. a vehicle location record receiving module configured for receiving at least one vehicle location record, at intervals, from said vehicle on a trip;
b. a data processor configured for:
i. extracting trip data from said vehicle location record;
ii. extracting previous trip data from a database, the previous trip data comprising:
1. a scheduled travel time for each stop on said trip;
2. historical travel times; and
3. recent travel times;
iii. updating said database with said trip data;
iv. identifying a most recent stop and at least one future stop corresponding to said trip based on said trip data;
v. establishing a link:
1. between said most recent stop and a first future stop; and
2. where there are at least two of said future stop, between each of said future stop;
vi. determining a travel distance for each of said link;
vii. determining a link travel time estimate corresponding to each of said travel distance using a weighted composite comprising:
1. said scheduled travel time;
2. said historical travel times;
3. said recent travel times; or
4. a scalable, weighted combination thereof;
viii. generating said ETA for each of said future stop by cumulatively adding said link travel time estimate of each said future stop to a current time set by said server; and
ix. uploading said ETA for each of said future stop into said database for retrieval; and
c. a memory.

10. The processor according to claim 9, wherein the data processor comprises:
a. a data extraction module configured for:
i. the extracting of said trip data from said vehicle location record;
ii. the extracting previous trip data from said database, the previous trip data comprising:
1. said scheduled travel time for each stop on said trip;
2. said historical travel times; and
3. said recent travel times;
b. a data uploading module configured for the updating of said database with said trip data;
c. a stop identifier module configured for the identifying of said most recent stop and said at least one future stop corresponding to said trip based on said trip data;
d. a link generator module configured for the establishing of said link:
1. between said most recent stop and said first future stop; and
2. where there are said at least two of said future stop, between each of said future stop;
e. a travel distance determiner module configured for the determining of said travel distance for each of said link;
f. a link travel time estimation module configured for the determining of said link travel time estimate corresponding to each of said travel distance using said weighted composite comprising:
1. said scheduled travel time;
2. said historical travel times;
3. said recent travel times; or
4. said scalable, weighted combination thereof;
g. an ETA generator module configured for the generating of said ETA for each of said future stop by cumulatively adding said link travel time estimate of each said future stop to said current time; and
h. an ETA uploading module configured for the uploading of said ETA for each of said future stop into said database for retrieval.

11. The processor according to claim 9, wherein said travel distance for said vehicle that has departed said most recent stop is the untraveled distance between the current position of said vehicle and said first future stop.

12. The processor according to claim 11, wherein said link travel time estimate for said travel distance is the time it takes for said vehicle to travel said untraveled distance.

13. The processor according to claim 9, wherein said scheduled travel time is about 20% of said weighted composite.

14. The processor according to claim 9, wherein said historical travel time is about 30% of said weighted composite.

15. The processor according to claim 9, wherein said recent travel time is about 50% of said weighted composite.

16. The processor according to claim 9, wherein if said most recent stop is a terminal stop, then said first future stop is the first immediate stop of a next trip.

17. A non-transitory, tangible computer readable medium including instructions for performing a method, when executed by at least one processor on a computing device, for determining the estimated time of arrival of a vehicle for a stop, said method comprising:
a. receiving at least one vehicle location record in timed intervals from said vehicle on trip via a processor on a computing device;
b. extracting trip data from said vehicle location record via said processor on a computing device;
c. extracting previous trip data from a database via said processor on a computing device, the previous trip data comprising:
i. a scheduled travel time for each stop on said trip;
ii. historical travel times; and
iii. recent travel times;
d. updating said database with said trip data via said processor on a computing device;
e. identifying a most recent stop and at least one future stop corresponding to said trip based on said trip data via said processor on a computing device;
f. establishing a link via said processor on a computing device:
i. between said most recent stop and a first future stop; and
ii. where there are at least two of said future stop, between each of said future stop;
g. determining a travel distance for each of said link via said processor on a computing device;
h. determining a link travel time estimate, via said processor on a computing device, wherein said link travel time estimate corresponds to each of said travel distance, by using a weighted composite comprising:
i. said scheduled travel time;
ii. said historical travel times;
iii. said recent travel times; or
iv. a scalable, weighted combination thereof;
i. generating, via said processor on a computing device, said ETA for each of said future stop by cumulatively adding said link travel time estimate of each said future stop to a current time; and
j. uploading, via said processor on a computing device, said ETA for each of said future stop into said database for retrieval.

18. The non-transitory, tangible computer readable medium according to claim 17, wherein said travel distance for said vehicle that has departed said most recent stop is the untraveled distance between the current position of said vehicle and said first future stop.

19. The non-transitory, tangible computer readable medium according to claim 18, wherein said link travel time estimate for said travel distance is the time it takes for said vehicle to travel said untraveled distance.

20. The non-transitory, tangible computer readable medium according to claim 17, wherein about 20% of said weighed composite is scheduled travel time, about 30% of said weighted composite is historical travel time, and about 50% of said weighted composite is said recent travel time.
